(19) United States
(12) Patent Application Publication
(10) Pub. No.: US 2021/0362163 A1
(43) Pub. Date: Nov. 25, 2021

(54) AUTOMATED PATHOGEN CLEANER

(71) Applicant: Robert BOYKIW, Vancouver (CA)

(72) Inventor: Robert BOYKIW, Vancouver (CA)

(21) Appl. No.: 17/327,293

(22) Filed: May 21, 2021

Related U.S. Application Data
(60) Provisional application No. 63/029,077, filed on May 22, 2020.

(51) Int. Cl. B03C 3/41; B03C 3/12; B03C 3/08; B03C 3/47

(52) U.S. Cl. CPC B03C 3/41; B03C 3/12; B03C 2201/10; B03C 3/47; B03C 2201/04; B03C 3/08

(57) ABSTRACT

There is provided an automated pathogen cleaner. The automated pathogen cleaner includes an air ionizer subassembly configured to ionize air and thereafter direct said air so ionized along a planar surface. The air so ionized couples with one or more pathogens on or adjacent to the planar surface. The automated pathogen cleaner includes a pathogen-collecting subassembly configured to collect said ionized air and at least disrupt functioning of said one or more pathogens so coupled with the ionized air.

### BACKGROUND OF THE INVENTION

### Field of the Invention

There is provided an automated pathogen cleaner, and a building comprising the same. In particular, there is provided an automated pathogen cleaner for the interior air and surfaces of a building.

### Description of the Related Art

U.S. Pat. No. 8,388,900 to Benedek discloses an assembly and method for treating or otherwise improving an atmosphere contained within an enclosed space. The enclosed space can be a container such as a bag or other housing for equipment, food and/or suitable material. Ozone is generated within an atmosphere that is exposed to the material. The generated ozone is mixed with the atmosphere. At least a portion of the generated ozone is then removed from the mixed atmosphere. The assembly and method can be used to treat contaminated sports equipment and the like, as well as to treat food storage atmospheres, such as those exposed to fresh fruits and vegetables.

U.S. Pat. No. 8,834,803 to Sunderland discloses a display assembly for containing and displaying perishable products. The display assembly includes a case having at least one wall and defining an internal volume. The display assembly includes a quantity of gas contained in the case. The gas includes ethylene emitted from the perishable products. The display assembly includes an electro hydrodynamic thrust device positioned in the case. The electro hydrodynamic thrust device ionizes a portion of the quantity of gas. The ionized gas includes at least one reactive oxygen species, and the at least one reactive oxygen species reacts with the ethylene to break down the ethylene.

United States Patent Application Publication No. 2002/0150500 A1 to Carman discloses a gaseous blend of Ox and a method for significantly reducing the biological load, including anthrax, on mail and shipping parcels. The gaseous blend of Ox consists at least in part of O₃. The method involves applying a continuous stream of oxygen-containing, i.e., Ox, gas to the mail or shipping parcel at a predetermined temperature, pressure and relative humidity. The continuous stream of Ox gas is prepared in an Ox generation cell, which contains a means for generating the Ox gas at a pressure less than 20 lbs/in2 using, for example, one or more of the following: corona discharge, high frequency electrical discharge, ultraviolet light, x-ray, radioactive isotope and electric beam.

### BRIEF SUMMARY OF INVENTION

There is provided, and it is an object to provide, an improved automated pathogen cleaner for air quality and surfaces.

There is accordingly provided an automated pathogen cleaner according to a first aspect. The automated pathogen cleaner includes an air ionizer subassembly configured to ionize air and thereafter direct said air so ionized along a planar surface. The air so ionized couples with one or more pathogens on or adjacent to the planar surface. The automated pathogen cleaner includes a pathogen-collecting subassembly configured to collect said ionized air and at least disrupt functioning of said one or more pathogens so coupled with the ionized air.

There is further provided an automated pathogen cleaner according to a second aspect. The automated pathogen cleaner includes an air ionizer. The automated pathogen cleaner includes an air expelling manifold in fluid communication with the air ionizer and positioned adjacent to a first end of an interior surface of a building. The interior surface could be the wall of a hallway, for example. The automated pathogen cleaner includes an air collecting manifold positioned adjacent to a second end of the interior surface of the floor of building. The automated pathogen cleaner includes a pathogen disrupter in fluid communication with the air collecting manifold.

There is also provided an automated pathogen cleaner according to a third aspect. The building includes an air expelling subassembly positioned adjacent to a first end of an interior surface of a building. Pressurized, ionized air is directed downwards from the air expelling subassembly and adjacent to said interior surface. The building includes an air collecting subassembly positioned adjacent to a second end of the interior surface. The pressurized, ionized air is received within the air collecting subassembly. The air collecting subassembly includes a pathogen disrupter configured to inhibit spreading of pathogens therefrom.

### BRIEF DESCRIPTION OF DRAWINGS

The invention will be more readily understood from the following description of preferred embodiments thereof given, by way of example only, with reference to the accompanying drawings, in which:

FIG. 1 is a top, front, end perspective view of an automated pathogen cleaner according to a first aspect, together with a room of a building within which the automated pathogen cleaner is located, the automated pathogen cleaner being shown partially schematically;

FIG. 2 is a front elevation view of a threshold assembly of the automated pathogen cleaner of FIG. 1;

FIG. 3 is a right side elevation view thereof;

FIG. 4 is a right side, front, top perspective view thereof; and

FIG. 5 is a top, front, end perspective view of an automated pathogen cleaner according to a second aspect, together with a room of a building within which the automated pathogen cleaner is located, the automated pathogen cleaner being shown partially schematically.

### DESCRIPTION OF THE PREFERRED EMBODIMENTS

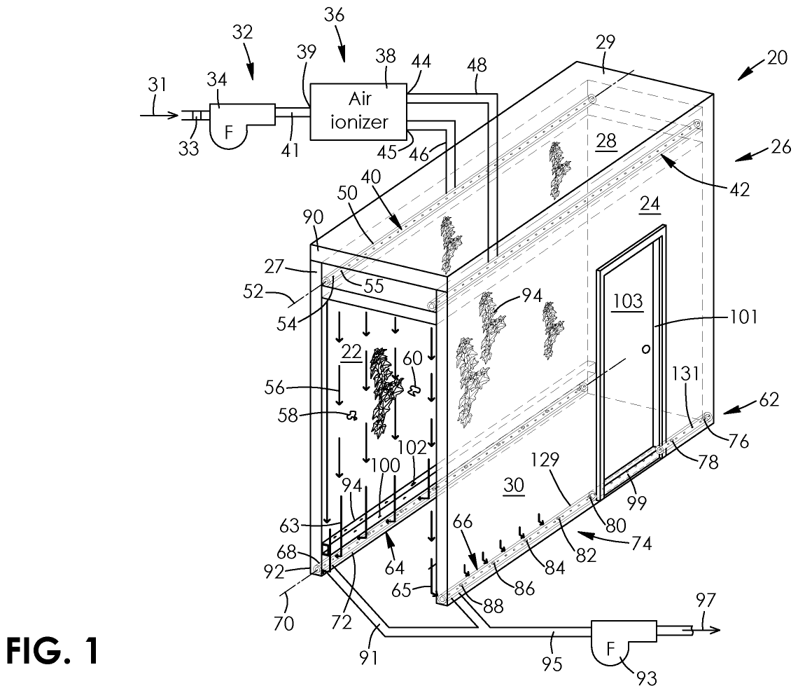

Referring to the drawings and first to FIG. 1, there is shown a building 20. The building includes a pair of spaced-apart walls 22 and 24 of a room, in this example a hallway 26, in this example. The hallway includes a ceiling 28 extending between the walls. The hallway 26 includes a floor 30 spaced-apart from the ceiling and extending between the walls 22 and 24. The hallway has a first end 27 and a second end 29.

There is further provided a cleaning assembly, in this example an automated pathogen cleaner 32 for the building 20. As seen in FIG. 1, the automated pathogen cleaner includes at least one air pressurizer, in this example a fan 34. The fan receives outside air 31 via a filter 33 in this case.

The automated pathogen cleaner 32 includes an air ionizer subassembly 36. The air ionizer subassembly includes an air ionizer 38. Air ionizers per se, including their various parts and functionings, are known to those skilled in the art and thus air ionizer 38 will not be described in further detail. The fan 34 is in fluid communication with and provides inlet 39 of the air ionizer with pressurized air via conduit 41.

The air ionized subassembly 36 includes at least one and in this example a pair of spaced-apart ionized air expelling manifolds 40 and 42. The air expelling manifolds are in fluid communication with the outlets 44 and 45 of air ionizer 38 via conduits 46 and 48 in this example. The air expelling manifolds 40 and 42 are positioned adjacent to first ends of respective interior surfaces of the building 20: in this example air expelling manifolds are positioned adjacent to and extend along the ceiling 28 and respective walls 22 and 24. The air expelling manifolds 40 and 42 extend between ends 27 and 29 of the hallway 26 in this example. The air expelling manifolds may include air filters therewithin, such as according to filtration ISO class 1, for example.

Each air expelling manifold 40 comprises an elongate outlet conduit 50 having a longitudinal axis 52 in this example. Each conduit has a plurality of longitudinally spaced-apart apertures 54 extending therein. Each air expelling manifold 40 includes a plurality of longitudinally spaced-apart jets or nozzles 55 through which air passes. These nozzles will vary in size to coordinate with room/area sizes as will the size of the one or more air expelling manifolds. The air expelling manifolds 40 and 42 may be said to comprise conduits with outlets positioned adjacent to first ends of the planar surfaces.

The air so ionized by air ionizer 38 exits from the air expelling manifolds 40 and 42 and is directed along planar surfaces, in this example downwards along walls 22 and 24, as shown by arrows of numeral 56. Fan 34, which may be but need not be on the roof (not shown) of the building 20, is configured to promote the downward movement of the ionized air directed along the walls. The air ionizer subassembly 36 as herein described may thus be said to be positioned adjacent to a first end of an interior surface of a building and via which pressurized, ionized air is directed downwards and adjacent to said interior surface. The air ionizer assembly is thus configured to ionize air and thereafter direct said air so ionized along the walls 22 and 24 of the hallway 26. The air so ionized couples with one or more pathogens 58 and 60 on or adjacent to the walls and is drawn downwards

The automated pathogen cleaner 32 includes an air collecting subassembly, in this example a pathogen-collecting assembly 62. The pathogen-collecting subassembly further includes at least one and in this example a pair of spaced-apart ionized air collecting manifolds 64 and 66 via which the air so ionized is collected. The air collecting manifolds are positioned adjacent to and extend along second ends of respective interior surfaces of the building: the air collecting manifolds are positioned adjacent to and extend along the floor 30 and respective walls 22 and 24 of the hallway 26 in this embodiment. The air collecting manifolds 64 and 66 extend between ends 27 and 29 of the hallway 26 in this example.

Each air collecting manifold comprises an elongate outlet conduit 68 having a longitudinal axis 70 in this example. The conduit has a plurality of longitudinally spaced-apart apertures 72 extending therein. Axes 52 and 70 of conduits 50 and 68 extend parallel with each other in this example. The air collecting manifolds 64 and 66 may be said to comprise conduits with inlets positioned adjacent to second ends of the planar surfaces and via which the air 56 so ionized is collected. Each air collecting manifold may thus be referred to and comprise a receptacle shaped to collect the ionized air. Conduits 50 and 68 may be at least partially clear or transparent in one embodiment.

The pathogen-collecting assembly 62 includes a pathogen disrupter 74 in fluid communication with the air collecting manifolds. The pathogen disrupter is configured to disrupt one or more pathogens 58 and 60 collected from the walls 22 and 24 via ionized air passing along the walls from the ionized air expelling manifold 40 and 42 to the ionized air collecting manifolds 64 and 66, as shown by arrows 63 and 65. The pathogen disrupter is thus configured to inhibit spreading of pathogens therefrom. In this example the pathogen disrupter comprises one or more ultraviolet lights emitting ultraviolet radiation, in this example a plurality of longitudinally spaced-apart lights 76, 78, 80, 82, 84, 86 and 88 positioned outside or within respective air collecting manifolds 66 and directed towards said one or more pathogens 58 and 60 so coupled with the ionized air. The lights may be UVA, UVB or UVC lights, or similar lights, for example. However, this is not strictly required and the pathogen disrupter may comprise another form in other embodiments. The exhausted air is thus treated with ultraviolet radiation in this example.

The pathogen-collecting subassembly 62 is thus configured to collect said ionized air and at least partially disrupt functioning of said one or more pathogens so coupled with the ionized air. The pathogen-collecting subassembly may thus be said to be positioned adjacent to second ends of the interior surfaces and via which the pressurized, ionized air is received.

In operation, the air 56 so ionized is directed along walls 22 and 24 from adjacent ceiling 28 to adjacent floor 30 of the hallway 26. The air ionizer subassembly 36 is thus positioned to direct the air so ionized from the top 90 of each wall, along and adjacent to the wall, and towards the bottom 92 of each wall. The pathogen-collecting subassembly 62 is thus positioned to collect the air so ionized adjacent to the bottom of each wall. The air so ionized and directed functions to inhibit the presence of pathogens on the walls 22 and 24 and draws other pathogens and particles out of the air in the hall or room.

Positive and negative ions may function to inactivate said pathogens, such as viruses, for example. Air ionizers and their connection to negative ions may result in significant benefits to one's respiratory system and overall health. The use of negative ions in the air may improve air quality through the removal of dust, allergens, pollen, pet dander, mold spores and other airborne bacteria.

As seen in FIG. 1, the automated pathogen cleaner 32 includes in this example a second pump or fan 93 in fluid communication with the air collecting manifolds 64 and 66 via conduits 91 and 95. The second fan functions to control and balance air volumes and flow by optimizing a low level of air turbulence by suction or vacuum and may remove contaminated air 97 from the building 20.

The automated pathogen cleaner 32 further includes vegetation 94. The vegetation is along wall 22 and extends along the wall between the ceiling 28 and floor 30 of the hallway 26 in this embodiment; however this is not strictly required. The vegetation 94 may comprise high oxygen and negative ion producing plants, such as ivy, for example. Such vegetation may be particularly applicable to form green walls which surround elevator vestibules, extend about lobby rooms and/or extend about and adjacent to elevator doors. The plants such as ivy may be effective at cleansing benzene, formaldehyde, xylene and toluene from the air. Negative ions may neutralize free pathogen radicals, and also clear the air of dust, pet dander and cigarette smoke while the higher humidity the plants may assist in the radical bonding process.

The automated pathogen cleaner 32 further includes in this example a trough 98 adjacent to the bottom 92 of each of the walls 22 having plants, with water 100 and hydroponic nutrients 102 therein in this example. The trough promote growth of the vegetation 94 on the walls 22 and 24. Such vegetation 94 and trough may function to increase humidity in the hallway 26.

The automated pathogen cleaner 32 as herein described may thus effectively wash the walls 22 and 24 of the hallway 26 and be optimized for pathogen removal.

The fan 34 may be configured to increase the intake air pressure compared to the air pressure typically present in a building 20, with a portion of the air flow traveling down the walls 22 and 24 and the balance of the air flow still meeting fire code requirements.

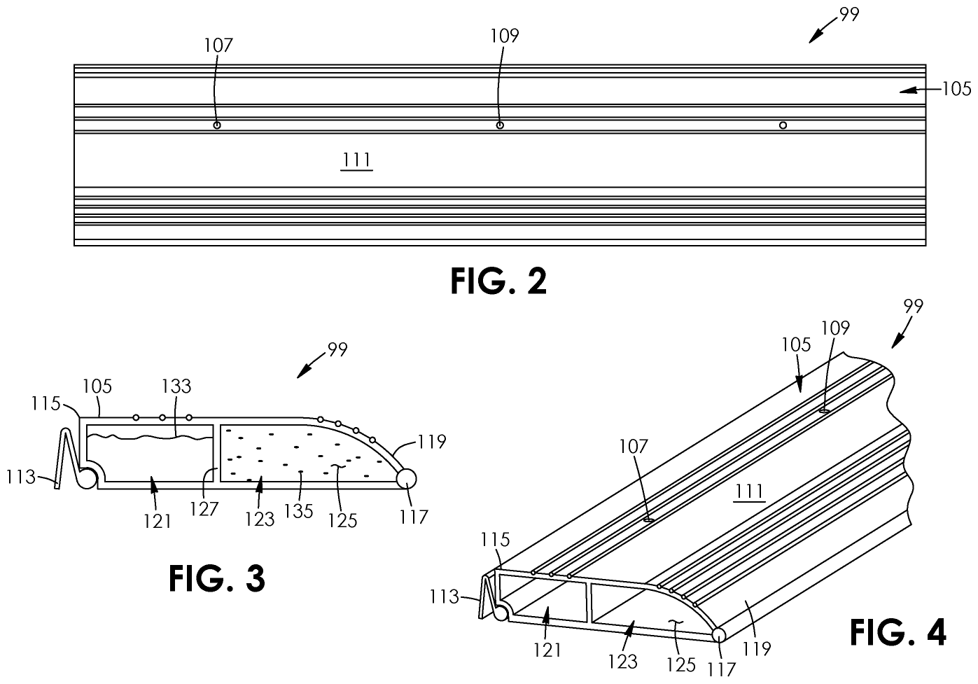

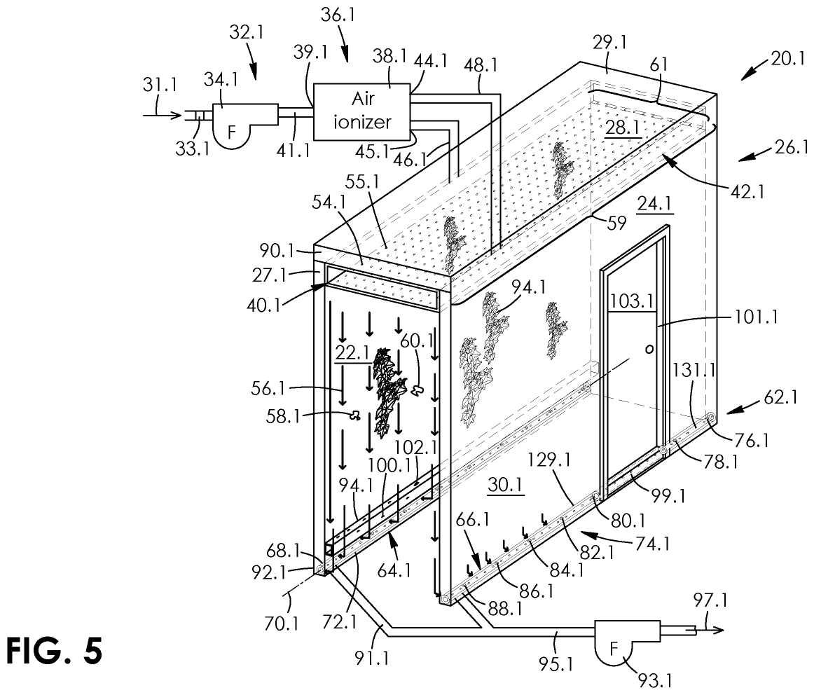

As seen in FIGS. 2 to 4, the automated pathogen cleaner 32 includes a threshold assembly 99 shaped to extend across the threshold 101 of a door 103 seen in FIG. 1. As seen in FIG. 4, the threshold assembly includes a doorsill 105 that is mounted in place via fasteners (not shown) which extend through apertures, in this example screw mount holes 107 and 109. The screw mount holes extend through the top 111 of the doorsill. As seen in FIG. 3, the threshold assembly 99 includes a first gasket 113 extending along a rear 115 thereof and a second gasket 117 extending along a front 119 thereof.

As seen in FIGS. 3 and 4, the threshold assembly 99 includes a pair of channels, in this example an enclosed water channel 121 and an enclosed air channel 123 within the interior 125 thereof. The channels are separated by divider 127 positioned between gaskets 113 and 117. Water channel 121 is in fluid communication with and configured to provide water to trough 98 seen in FIG. 1 and is shaped to receive water 133 therein and therethrough. Referring back to FIGS. 3 and 4, air channel 123 is in fluid communication with sub-sections 129 and 131 of air collecting manifold 66 seen in FIG. 1 and is configured to receive ionized air 135 therein and therethrough. Door 103 is interposed between the sub-sections of the air collecting manifold.

FIG. 5 shows a building 20.1 and automated pathogen cleaner 32.1 according to a second aspect. Like parts have like numbers and functions as the building 20 and automated pathogen cleaner 32 shown in FIGS. 1 to 4 with the addition of decimal extension “.1”. Building 20.1 and cleaner 32.1 are substantially the same as building 20 and cleaner 32 shown in FIGS. 1 to 4 with the following exceptions.

Air expelling manifold 40.1 couples to, extends and covers ceiling 28.1 in this example from wall 22.1 to wall 24.1. The manifold is a duct that is hollow and rectangular in shape in this example. The manifold 40.1 includes a plurality of apertures 54.1 and 55.1 arranged in rows 59 and columns 61. Air ionizer subassembly 36.1 is positioned to direct the air 56.1 so ionized from uniformly downwards from the ceiling 28.1 to the floor 30.1, with the air thereafter being collected by respective ionized air collecting manifolds 64.1 and 66.1 as shown by arrows 63.1 and 65.1.

It will be appreciated that many variations are possible within the scope of the invention described herein. The automated pathogen cleaner may be referred to a building cleaning assembly, an automated wall and hall cleaning assembly, an automated hall and wall sanitizer, or a hygienic automated pathogen sanitizer, for example.

The air expelling manifolds as herein described may be referred to as clean air manifolds, air expeller manifolds, or air dispersing manifolds. The air collecting manifolds as herein described may be referred to as contaminated air manifolds, or air receiving manifolds, for example.

The pathogen disabler as herein described may be referred to as a pathogen disrupter or impairer.

### ADDITIONAL DESCRIPTION

Examples of automated pathogen cleaners have been described. The following paragraphs are offered as further description.

The building as herein described may include a green wall increasing humidity and adding to the efficiency of the automated pathogen cleaner.

The design and concept for the automated pathogen cleaner begins on the roof and/or other appropriate air intake points where the air is further filtered and ionized and pumped to each floor to wash the common corridors walls via small penetration in a continuous conduit at the edge of the walls and ceiling interface. As the ionized air is directed down the wall the negatively charged ions pick up bacteria, viruses and pathogens while the green vestibule walls (ivy and other crassulacean acid metabolism (CAM) plants) maintain a high humidity 70-80% with 24 hour oxygen production environmental growing in a hydroponic medium. (These same plants assist residents with allergies in their natural operation). The automated pathogen cleaner as herein described may be said to supercharge ionized air that normally bonds to pathogens, in a balanced environment, bonding to pathogens, that with their added weight assisted by the controlled air flow and gravity to the exhaust vents where ultraviolet radiation lighting attached outside of the clear pipe promotes disruption of the pathogens but still provides oxygenated air with free radicals and antioxidants disperse to the neighbourhood and atmosphere. It should be noted the air volumes are designed to maintain fire safety and optimizing molecular wall washing/cleaning. The ultraviolet radiation lights can have an amplification system so when it is safe; to clean the full hallway floor. The automated pathogen cleaner may assist one's health inside and outside the building while dramatically reducing pandemic risks. The automated pathogen cleaner as herein described may be a breakthrough in this pandemic era.

It will be understood by someone skilled in the art that many of the details provided above are by way of example only and are not intended to limit the scope of the invention which is to be determined with reference to at least the following claims.

What is claimed is:

1. An automated pathogen cleaner comprising:
an air ionizer;
an air expelling manifold in fluid communication with the air ionizer and positioned adjacent to a first end of an interior surface of a building;
an air collecting manifold positioned adjacent to a second end of the interior surface of the building; and
a pathogen disabler in fluid communication with the air collecting manifold.

2. The automated pathogen cleaner of claim 1, wherein the air so ionized and directed functions to inhibit the presence of pathogens on the interior surface of the building.

3. The automated pathogen cleaner of claim 1 wherein the pathogen disabler comprises ultraviolet light.

4. The automated pathogen cleaner of claim 1, wherein the interior surface is a wall, wherein the air expelling manifold is positioned to direct ionized air from a top of the wall, along and adjacent to the wall, and towards a bottom of the wall, and wherein the air collecting manifold is positioned to collect the air so ionized adjacent to the bottom of the wall.

5. The automated pathogen cleaner as claimed in claim 1, including an air expelling subassembly positioned adjacent to the first end of the interior surface of the building and via which pressurized, ionized air is directed downwards and adjacent to said interior surface.

6. The automated pathogen cleaner as claimed in claim 1, including an air collecting subassembly positioned adjacent to the second end of the interior surface and via which the pressurized, ionized air is received, the air collecting subassembly including the pathogen disabler configured to inhibit spreading of pathogens therefrom.

7. The automated pathogen cleaner of claim 1 wherein the air expelling manifold includes at least one elongate outlet conduit having a plurality of longitudinally spaced-apart apertures extending therethrough and via which the air so ionized exits and is directed along the interior surface of the building.

8. The automated pathogen cleaner of claim 1, wherein the air collecting manifold includes at least one elongate inlet conduit having a plurality of longitudinally spaced-apart apertures extending therethrough and via which the air so ionized is collected.

9. The automated pathogen cleaner of claim 8, wherein the pathogen disabler comprises a plurality of longitudinally spaced-apart ultraviolet lights positioned within the at least one elongate inlet conduit.

10. The automated pathogen cleaner of claim 1 wherein the air collecting manifold is configured to direct ionized air uniformly downwards from a ceiling of the building towards a floor of the building.

11. The automated pathogen cleaner of claim 10 wherein the air collecting manifold includes a pair of elongate inlet conduits extending adjacent the floor of the building and along opposed walls of the building, each said elongate inlet conduit having a plurality of longitudinally spaced-apart apertures extending therethrough and via which the air so ionized is collected.

12. The automated pathogen cleaner of claim 1 wherein the air collecting manifold includes a pair of elongate inlet conduits extending adjacent a floor of the building and along opposed walls of the building, each said elongate inlet conduit having a plurality of longitudinally spaced-apart apertures extending therethrough and via which the air so ionized is collected, and wherein the automated pathogen cleaner further includes a doorsill assembly with an elongate channel in fluid communication with said elongate inlet conduits.

13. The automated pathogen cleaner of claim 1 further including a first fan which provides the air ionizer with pressurized air, and a second fan in fluid communication with the air collecting manifold, the second fan creating a suction pressure which promotes collecting of the pressurized air passing along the interior surface of the building.

14. The automated pathogen cleaner as claimed in claim 1, further including vegetation emitting negative ions in fluid communication with said interior surface of the building.

15. The automated pathogen cleaner of claim 14 further including a trough adjacent said interior surface of the building, and shaped to receive nutrients and water therein to facilitate growth of the vegetation.

16. The automated pathogen cleaner of claim 15, further including one or more elongate inlet conduits having a plurality of longitudinally spaced-apart apertures extending therethrough and via which the air so ionized is collected, and a doorsill assembly with a water channel in fluid communication with said trough and an air channel in fluid communication with said one or more elongate inlet conduits.

17. An automated pathogen cleaner for a room having a ceiling, a floor and a pair of opposed walls extending between the ceiling and the floor thereof, the automated pathogen cleaner comprising:
an air ionizer;
an air expelling manifold in fluid communication with the air ionizer, and shaped to couple to and span the ceiling. a pair of air collecting manifolds shaped to couple to the opposed walls of the building adjacent the floor of the building; and
a pathogen disabler in fluid communication with the air collecting manifold.

18. The automated pathogen cleaner of claim 17 wherein the air expelling manifold is hollow and rectangular in shape.

19. The automated pathogen cleaner of claim 17 wherein the air expelling manifold has a plurality of apertures extending in rows and columns which span a ceiling of the building and via which the air so ionized exits and is directed along the interior surface of the building.

20. A building comprising:
a pair of spaced-apart walls;
a ceiling extending between the walls;
a floor spaced-apart from the ceiling and extending between the walls;
a first ionized air expelling manifold positioned adjacent to and extending along the ceiling and a first said wall;
a second ionized air expelling manifold positioned adjacent to and extending along the ceiling and a second said wall;
a first ionized air collecting manifold positioned adjacent to and extending along the floor and the first said wall; and
a second ionized air collecting manifold positioned adjacent to and extending along the floor and the second said wall.
